(19) United States
(12) Patent Application Publication
(10) Pub. No.: US 2020/0388172 A1
(43) Pub. Date: Dec. 10, 2020

(54) OBSTACLE AVOIDANCE CONTROL METHOD FOR UNMANNED AERIAL VEHICLE, RADAR SYSTEM, AND UNMANNED AERIAL VEHICLE

(71) Applicant: SZ DJI TECHNOLOGY CO., LTD., Shenzhen (CN)

(72) Inventors: Chunming WANG, Shenzhen (CN); Xumin WU, Shenzhen (CN); Junxi WANG, Shenzhen (CN)

(21) Appl. No.: 16/857,921

(22) Filed: Apr. 24, 2020

Related U.S. Application Data
(63) Continuation of application No. PCT/CN2017/108561, filed on Oct. 31, 2017.

(51) Int. Cl. G08G 5/04; B64C 39/02; G05D 1/10; G01S 13/933; G08G 5/00

(52) U.S. Cl. CPC G08G 5/045; B64C 39/024; B64C 2201/141; G01S 13/933; G08G 5/0021; G05D 1/106

(57) ABSTRACT

An unmanned aerial vehicle (UAV) obstacle avoidance control method includes: controlling a rotation device to perform a continuous rotation that drives a radar detecting device to rotate continuously. The rotation device is disposed on a body of a UAV and carries the radar detecting device. The method also includes: acquiring detection information of the radar detecting device during the continuous rotation; and controlling the UAV to fly based on the detection information.

### CROSS-REFERENCE TO RELATED APPLICATION

This application is a continuation of International Application No. PCT/CN2017/108561, filed on Oct. 31, 2017, the entire content of which is incorporated herein by reference.

### TECHNICAL FIELD

The present disclosure relates to the field of unmanned aerial vehicle (UAV) and, more specifically, to an obstacle avoidance control method for UAV, a radar system, and a UAV.

### BACKGROUND

In conventional technology, a UAV generally includes a detecting device. The detecting device can be used to detect objects around the UAV, such as detecting obstacles around the UAV, to prevent the UAV from colliding with the obstacles.

In conventional technology, the detecting device carried on the UAV generally includes a visual sensor and an ultrasonic sensor. The resolution of the visual sensor is relatively high, however, the visual sensor can be easily affected by the environment. In the environment where visibility is low, the detection distance of the visual sensor can be limited. The ultrasonic sensor is less affected by the environment, however, the ultrasonic sensor has a relative short detection and a relatively low resolution.

As such, a detection method that is neither affected by the environment, has high resolution, and has a long detection distance is needed.

### SUMMARY

A first aspect of the present disclosure provides an unmanned aerial vehicle (UAV) obstacle avoidance control method. The method includes: controlling a rotation device to perform a continuous rotation that drives a radar detecting device to rotate continuously. The rotation device is disposed on a body of a UAV and carries the radar detecting device. The method also includes: acquiring detection information of the radar detecting device during the continuous rotation; and controlling the UAV to fly based on the detection information.

A second aspect of the present disclosure provides a radar system that includes a radar detecting device and a rotation device. The rotation device is disposed on a body of a UAV and carries the radar detecting device. The rotation device is configured to drive the radar detecting device to continuously rotate. When the rotation device drives the radar detecting device to continuously rotate, the radar detecting device is configured to scan and detect an obstacle around the UAV.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a structural diagram of a radar system included in a UAV according to an embodiment of the present disclosure.

FIG. 2 is a structural diagram of the radar system included in the UAV according to an embodiment of the present disclosure.

FIG. 3 is a diagram of the UAV including the radar system according to an embodiment of the present disclosure.

FIG. 4 is a diagram of the UAV including the radar system according to an embodiment of the present disclosure.

FIG. 5 is a diagram of the UAV including the radar system according to an embodiment of the present disclosure.

FIG. 6 is a flowchart of a UAV obstacle avoidance control method according to an embodiment of the present disclosure.

FIG. 7 is a diagram of a digital bean forming (DBF) according to an embodiment of the present disclosure.

FIG. 8 is a diagram of scanning a first radio frequency antenna according to an embodiment of the present disclosure.

FIG. 9 is diagram of an obstacle avoidance of the UAV according to an embodiment of the present disclosure.

FIG. 10 is a diagram of the UAV including the radar system according to an embodiment of the present disclosure.

FIG. 11 is a diagram illustrating a UAV terrain tracking according to an embodiment of the present disclosure.

FIG. 12 is a structural diagram of the UAV according to an embodiment of the present disclosure.

### REFERENCE NUMERALS

10 Rotation axis
11 Radar system
12 Radar detecting device
13 Rotation device
121 Control circuit board
122 First radio frequency antenna
123 Second radio frequency antenna
131 Turntable
132 Electronic speed control board
133 Interface board
30 UAV
80 XOY plane
81 Scanning beam
82 Scanning beam
1200 UAV
1202 Supporting device
1204 Imaging device
1206 Propeller
1207 Motor
1208 Radar system
1210 Communication system
1212 Ground station
1214 Antenna
1216 Electromagnetic wave
1217 Electronic speed controller
1218 Flight controller

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be noted that, when a component is referred to as being “fixed to” another component, the component can be directly fixed to the other component or an intermediate component may exist. When a component is regarded to be “connected” to another component, the component can be directly connected to the other component or an intermediate component may exist.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings. Unless a conflict exists, the embodiments and features of the embodiments can be combined.

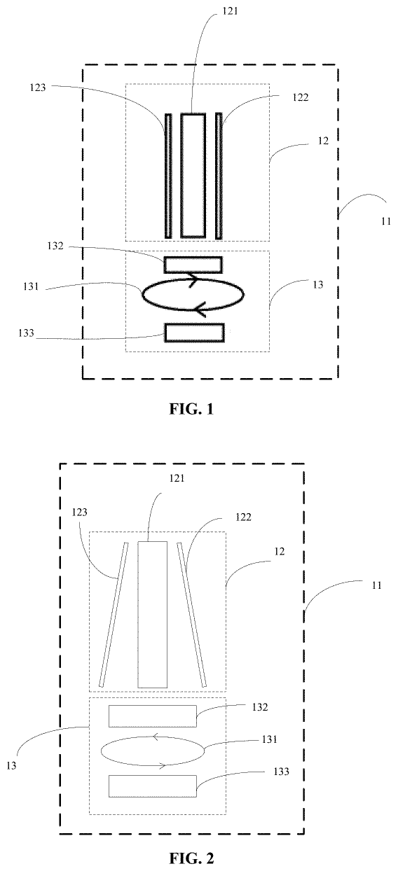

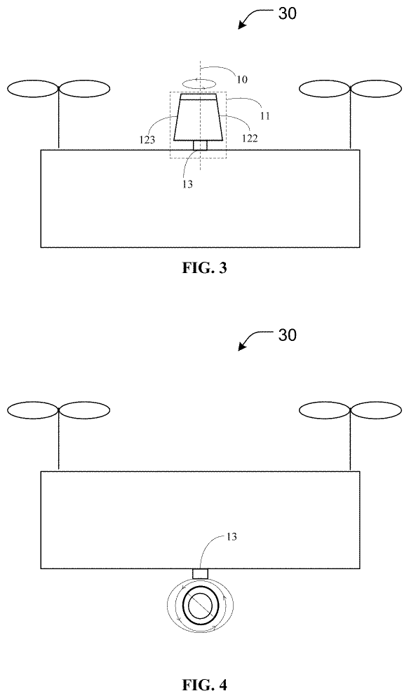

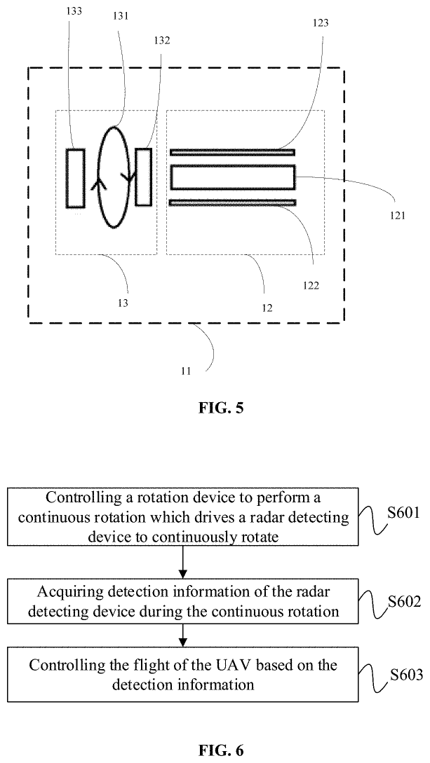

An embodiment of the present disclosure provides a method for controlling an obstacle avoidance of a UAV. FIG. 1 is a structural diagram of a radar system included in a UAV according to an embodiment of the present disclosure. FIG. 2 is a structural diagram of the radar system included in the UAV according to an embodiment of the present disclosure. FIG. 3 is a diagram of the UAV including the radar system according to an embodiment of the present disclosure. FIG. 4 is a diagram of the UAV including the radar system according to an embodiment of the present disclosure.

As shown in FIG. 1, a radar system 11 includes a radar detecting device 12 and a rotation device 13. The rotation device 13 may be disposed on the body of the UAV, and radar detecting device 12 may be disposed on the rotation device 13.

In some embodiments, the radar detecting device 12 may include a control circuit board 121 and one or more radio frequency (RF) antennas, and the control circuit board 121 and the one or more RF antennas may be electrically connected. More specifically, the radar detecting device 12 may include a control circuit board 121, a first RF antenna 122, and a second RF antenna 123. In particular, the control circuit board 121 may be disposed between the first RF antenna 122 and the second RF antenna 123.

As shown in FIG. 1, the board surface of the control circuit board 121 is parallel to the board surface of the first RF antenna 122, and the board surface of the control circuit board 121 is parallel to the board surface of the second RF antenna 123.

In some embodiments, an angle between the board surface of the RF antenna and the board surface of the control circuit board may be a predetermined angle. As shown in FIG. 2, the board surface of the control circuit board 121 is at a predetermined angle with the board surface of the first RF antenna 122, and the board surface of the control circuit board 121 is at a predetermined angle with the board surface of the second RF antenna 123.

In addition, as shown in FIG. 1 or FIG. 2, the rotation device 13 includes a turntable 131, an electronic speed control (ESC) board 132, and an interface board 133. The turntable 131 may be configured to carry the radar detecting device 12, the ESC board 132 may be electrically connected to a motor for driving the motor to rotate and control a rotation state of the motor. The motor may be used to drive the turntable 131 to rotate. The interface board 133 may be electrically connected to the ESC board 132 and/or the radar detecting device 12. Further, the interface board 133 may be used for an external electrical connection.

The radar system 11 may be mounted on the UAV in various manners.

In some embodiments, as shown in FIG. 3, the radar system is vertically mounted above the body of a UAV 30, as such, a rotation axis 10 of the radar system 11 is parallel to the yaw axis of the UAV 30. At this time, the attitude of the radar system 11 relative to the UAV 30 may be as shown in FIG. 1 or FIG. 2. Using FIG. 2 as an example, that is, the board surface of the control circuit board 121 may be at a predetermined angle with the board surface of the first RF antenna 122, and the board surface of the control circuit board 121 may be at a predetermined angle with the board surface of the second RF antenna 123.

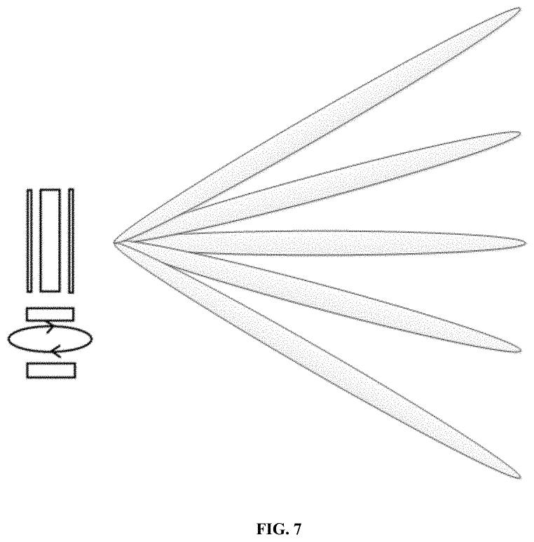

In some embodiments, as shown in FIG. 4, the radar system 11 is horizontally mounted below the body of a UAV 30, as such, the rotation axis 10 of the radar system 11 is perpendicular to the yaw axis of the UAV 30. At this time, the attitude of the radar system 11 relative to the UAV 30 may be as shown in FIG. 5. In some embodiments, on the basis of FIG. 5, the board surface of the control circuit board 121 may also be at a predetermined angle with the board surface of the first RF antenna 122, and the board surface of the control circuit board 121 may also be at a predetermined angle with the board surface of the second RF antenna 123.

FIG. 6 is a flowchart of a UAV obstacle avoidance control method according to an embodiment of the present disclosure. The method is described in detail below.

S601, controlling the rotation device to continuously rotate, so as to drive, by the rotation device, the radar detecting device to continuously rotate. In other words, the rotation device is controlled to perform a continuous rotation which drives the radar detecting device to continuously rotate.

The execution body of the method of this embodiment may be a flight controller of a UAV, or other general-purpose or dedicated processors. The present embodiment is described using a flight controller as an example.

As shown in FIGS. 1-5, the flight controller of the UAV 30 may be configured to control the continuous rotation of the rotation device 13, and the rotation device 13 may drive the radar detecting device 12 to continuously rotate when the rotation device 13 is continuously rotated. When the radar detecting device 12 is continuously rotated, obstacles around the UAV may be detected. For example, as shown in FIG. 3, the radar system 11 may scan for obstacles with a 360° range around the UAV 30.

S602, acquiring detection information of the radar detecting device during the continuous rotation.

During the continuous rotation of the radar detecting device 12, the flight controller of the UAV 30 may acquire the detection information of the radar detecting device 12 in real time. For example, as shown in FIG. 3, the radar system 11 may detect an obstacle in front of, behind, and above the UAV 30. Further, the radar system 11 may detect information such as distance, speed, direction, height, etc. of the obstacle relative to the UAV 30.

S603, controlling the flight of the UAV based on the detection information.

In some embodiments, the flight controller of the UAV 30 may control the UAV 30 to fly based on the detection information of the radar detecting device 12. For example, the flight controller of the UAV 30 may control the UAV to avoid obstacles.

In some embodiments, the radar detecting device 12 may detect a target object around the UAV using a digital beam forming (DBF). As shown in FIG. 7, the beam emitted by the radar detecting device 12 may specifically be a DBF. A continuously rotating scanning radar based on the DBF may be more adaptable to the environment, and the scanning resolution may satisfy the obstacle avoidance requirements.

In some embodiments, the UAV may include an agricultural UAV. That is, the radar system 11 described in this embodiment can be specifically applied to an agricultural UAV. In some embodiments, the radar system 11 can also be applied to other UAVs other the agricultural UAV.

In the present embodiment, the rotation device of the radar system may be controlled by the UAV to continuously rotate the rotation device. During the continuously rotation of the rotation device, the rotation device may drive the radar detecting device of the radar system to continuously rotate. The UAV may control the flight of the UAV based on the detection information of the radar detecting device during the continuously rotation of the rotation device. The continuous rotation of the radar detecting device can allow the detection of farther and wider areas. Further, a continuously rotating scanning radar may be more adaptable to the environment with a higher scanning resolution.

An embodiment of the present disclosure provides a method for controlling an obstacle avoidance of a UAV. On the basis of the embodiment shown in FIG. 6, the radar detecting device may be vertically mounted above the body of the UAV through the rotation device, and the rotation axis of the radar detecting device may be parallel to the yaw axis of the UAV.

As shown in FIG. 3, the radar system is vertically mounted above the body of the UAV 30, as such, the rotation axis 10 of the radar system 11 is parallel to the yaw axis of the UAV 30. At this time, the attitude of the radar system 11 relative to the UAV 30 may be as shown in FIG. 1 or FIG. 2. Using FIG. 2 as an example, that is, the board surface of the control circuit board 121 may be at a predetermined angle with the board surface of the first RF antenna 122, and the board surface of the control circuit board 121 may be at a predetermined angle with the board surface of the second RF antenna 123.

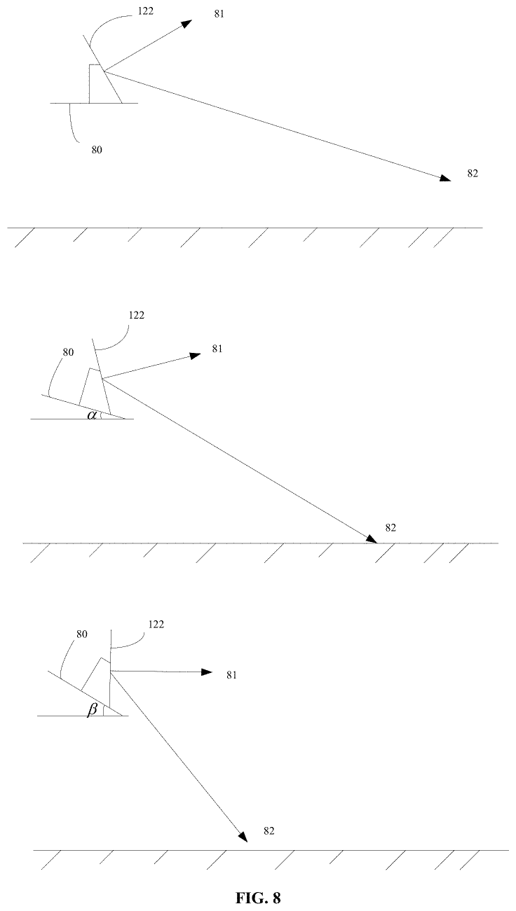

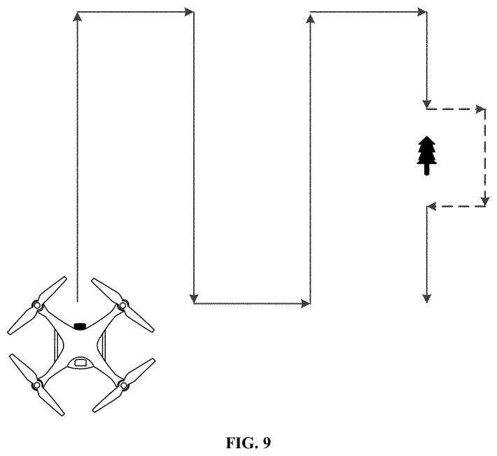

On the basis of FIG. 3, as shown in FIG. 8, reference numeral 80 represents an XOY plane of the body coordinate system of the UAV, reference numeral 122 represents a first RF antenna of the radar system 11, reference numeral 81 represents a scanning beam perpendicular to the plane of the first RF antenna 122, and arrow 82 represents a scanning beam at a predetermined angle to beam 81. It should be noted that FIG. 8 is merely an exemplary illustration, and the shape and range of the beam emitted by the first RF antenna 122 is not limited herein. When the pitch angle of the UAV is 0, the XOY plane of the body coordinate system may be parallel to the horizontal plane (e.g., as shown on top section of FIG. 8). When the pitch angle of the UAV is not 0, the XOY plane of the body coordinate system may be at an angle to the horizontal plane. α and β respectively indicate the pitch angle of the UAV, and the angle of the pitch angle α may be smaller than the angle of the pitch angle β. Based on FIG. 8, when the x-axis of the body coordinate system of the UAV is below the horizontal plane of the origin of the coordinate, as the angle of the pitch angle of the UAV increases, the range of the ground that the first RF antenna 122 (e.g., indicated by an angle between beam 81 and beam 82) can scan may continuously increase.

In some embodiments, the radar detecting device may be configured to detect one or more of an obstacle in front of, behind, or above the UAV.

In some embodiments, the detection information includes one or more of a distance, a speed, a direction, or a height of the obstacle relative to the UAV.

As shown in FIG. 3, the radar system 11 may detect an obstacle in front of, behind, and above the UAV 30. Further, the radar system 11 may detect information such as distance, speed, direction, height, etc. of the obstacle relative to the UAV 30.

In the present embodiment, controlling the flight of the UAV based on the detection information may be implemented in various manners.

In some embodiments, the UAV may be controlled to avoid the obstacle based on the detection information. After controlling the UAV to avoid the obstacle, the UAV may be further controlled to return to a predetermine route. As shown in FIG. 9, when the radar detecting system detects an obstacle in front of the UAV, the flight controller controls the UAV to avoid the obstacle based on the detection information of the radar detecting device during the continuous rotation. After avoiding the obstacle, the UAV is controlled to return the predetermined route to continue the flight.

In some embodiments, the predetermined route and/or pre-planned agricultural operation information may be adjusted based on the detection information, and the UAV may be controlled to continue the flight operation based on the adjusted route and/or the agricultural operation planning information.

More specifically, the flight controller may also be configured to adjust the route of the agricultural UAV operation, such as the length, width, and spacing of the route, based on the detection formation of the radar detecting device during the continuous rotation. Further, the flight controller may also be configured to adjust the planning information of an agricultural operation, such as the spray route, spray time, etc. When the flight controller adjusts the route of the agricultural UAV operation and/or the planning information of the agricultural UAV operation, the agricultural UAV may be controlled to continue the flight operation based on the adjusted route and/or planning information.

In the present embodiment, the radar detecting device may be vertically mounted on top of the body of the UAV through the rotation device to detect one or more obstacles in front of, behind, or above the UAV. The flight controller may be used to control the UAV to avoid obstacles based on the detection information of the radar detecting device to improve the safety of the flight of the UAV. Alternatively, the flight controller may be used to adjust the operation route and operation planning information of the UAV based on the detection information of the radar detecting device, thereby realizing the flexibility of the UAV operation control.

An embodiment of the present disclosure provides a method for controlling an obstacle avoidance of a UAV. On the basis of the embodiment shown in FIG. 6, the radar detecting device may be horizontally mounted under the body of the UAV through the rotation device, and the rotation axis of the radar detecting device may be perpendicular to the yaw axis of the UAV.

As shown in FIG. 4, the radar system 11 is horizontally mounted below the body of a UAV 30, as such, the rotation axis 10 of the radar system 11 is perpendicular to the yaw axis of the UAV 30. At this time, the attitude of the radar system 11 relative to the UAV 30 may be as shown in FIG. 5. In some embodiments, on the basis of FIG. 5, the board surface of the control circuit board 121 may also be at a predetermined angle with the board surface of the first RF antenna 122, and the board surface of the control circuit board 121 may also be at a predetermined angle with the board surface of the second RF antenna 123.

In some embodiments, a beam indicating the maximum detection direction of the radar detecting device and the yaw axis of the UAV may be at a predetermined angle.

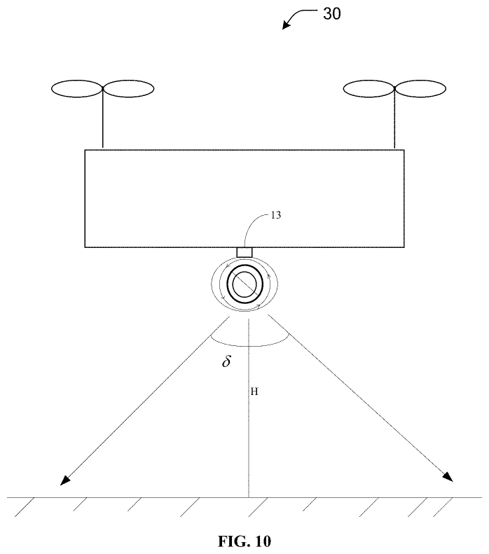

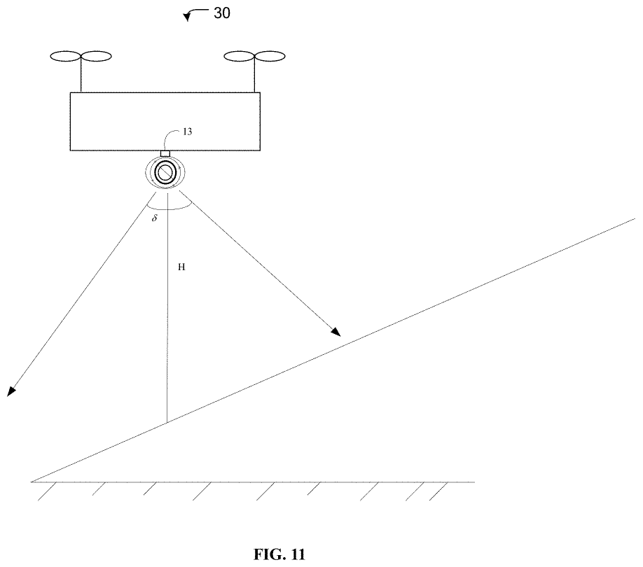

In some embodiments, the detection may include one or more of a height of the UAV from the ground or a terrain of the ground below the UAV within a predetermined angle. As shown in FIG. 10, when the radar system 11 is horizontally mounted under the body of the UAV 30, the radar system 11 may be used to detect a height H of the UAV from the ground, and a terrain of the ground below the UAV within an area associated with angle δ (e.g., a bottom face of a cone-shaped space defined by the height H and by the angle δ or directions of scanning beams). The range of the angle δ is not limited in the present disclosure. For example, the angle δ may equal two times the predetermined angle between the beam indicating the maximum detection direction of the radar detecting device and the yaw axis of the UAV.

In the present embodiment, controlling the flight of the UAV based on the detection information may be implemented in various manners.

In some embodiments, the flight height of the UAV may be controlled based on the height of the UAV from the ground. More specifically, the flight controller of the UAV may be configured to control the flight height of the UAV based on the height H of the UAV from the ground detected by the radar system 11.

In some embodiments, the UAV may be controlled to perform terrain tracking based on the terrain of the ground below the UAV within the predetermined angle.

As shown in FIG. 11, the UAV 30 may be an agricultural UAV. When the agricultural UAV is operating on a slope as shown in FIG. 11, the flight controller of the UAV may control the UAV based on the height H of the UAV from the ground detected by the radar system 11, such that the flight height of the UAV may be maintained within a predetermined height range to perform terrain tracking.

In addition, the flight controller can also control a climbing acceleration of the UAV when controlling the UAV to perform terrain tracking. For example, the climbing acceleration of the UAV may be A, the terrain angle may be α1, the angle of the radar system relative to the ground may be α2, the horizontal velocity of the UAV may be Vₕₛ, and the radar measuring oblique distance may be L. When the radar measuring oblique distance is L/2, the climbing acceleration of the UAV may be Vᵥₛ=tan α1*Vₕₛ, otherwise, the UAV may collide with the ground. The response time of the UAV may be t_{RD}, that is, the time when the radar measuring oblique distance changes from L to L/2. During the response time t_{RD}, the UAU needs to increase the climbing speed from 0 to Vᵥₛ. As such, the climbing acceleration of the UAV may be

$$A = \frac{{V}_{vs}}{{t}_{RD}} .$$

In addition, if

$${t}_{RD} = \frac{\frac{L}{2} sin α2}{{V}_{hs}} ,$$

then

$$A = \frac{{V}_{vs}}{\frac{\frac{L}{2} sin α2}{{V}_{hs}}} = \frac{2 {{V}_{vs}}^{*} {V}_{hs}}{L sin α2} = \frac{2 tan {α1}^{*} {V}_{hs}^{2}}{L sin α2} .$$

In the present embodiment, the radar detecting device may be horizontally mounted under the body of the UAV through the rotation device to detect the height of the UAV from the ground and the terrain of the ground below the UAV within a predetermined angle. The flight controller may be used to control the flight height of the UAV based on the detection information of the radar detecting device and control the UAV to perform terrain tracking, thereby improving the safety of the agricultural UAV during operation.

An embodiment of the present disclosure provides a radar system. As shown in FIG. 1, FIG. 2, FIG. 3, and FIG. 5, the radar system 11 includes the radar detecting device 12 and the rotation device 13, where the rotation device 13 is disposed on the body of the UAV. The radar detecting device may be disposed on the rotation device, and the rotation device 13 may be configured to drive the radar detecting device 12 to continuously rotate. In particular, when the rotation device 13 drives the radar detecting device 12 to continuously rotate, the radar detecting device 12 may scan and detect obstacles around the UAV.

In some embodiments, the radar detecting device may include a control circuit board and one or more radio frequency (RF) antennas, and the control circuit board and the one or more RF antennas may be electrically connected.

In some embodiments, an angle between the board surface of the RF antenna and the board surface of the control circuit board may be a predetermined angle.

In some embodiments, the radar detecting device may include a control circuit board, a first RF antenna, and a second RF antenna, and the control circuit board may be disposed between the first RF antenna and the second RF antenna.

In some embodiments, the rotation device may include a turntable configured to carry the radar detecting device, an ESC board electrically connected to a motor for driving the motor to rotate and control a rotation state of the motor, and an interface board electrically connected to the ESC board and/or the radar detecting device. In some embodiments, the motor may be used to drive the turntable to rotate, and the interface board may be used for an external electrical connection.

In some embodiments, the radar detecting device may detect a target object around the UAV using a digital beam forming (DBF).

The radar system may be mounted on the UAV in various manners.

In some embodiments, the radar detecting device may be vertically mounted above the body of the UAV through the rotation device, and the rotating axis of the radar detecting device may be parallel to the yaw axis of the UAV. The specific details are shown in FIG. 3, which will not be described herein again.

In some embodiments, the radar detecting device may be configured to detect one or more of an obstacle in front of, behind, or above the UAV.

In some embodiments, the detection information includes one or more of a distance, a speed, a direction, or a height of the obstacle relative to the UAV.

In some embodiments, the radar detecting device may be horizontally mounted under the body of the UAV through the rotation device, and the rotating axis of the radar detecting device may be perpendicular to the yaw axis of the UAV. The specific details are shown in FIG. 4, which will not be described herein again.

In some embodiments, the maximum detection direction of the radar detecting device and the yaw axis direction of the UAV may be at a predetermined angle.

In some embodiments, the detection may include one or more of a height of the UAV from the ground or a terrain of the ground below the UAV within a predetermined angle.

The specific principles and implementation manners of the radar system provided in the embodiments of the present disclosure are similar to the embodiment shown in FIG. 6, and details are not described herein again.

In the present embodiment, the rotation device of the radar system may be controlled by the UAV to continuously rotate the rotation device. During the continuously rotation of the rotation device, the rotation device may drive the radar detecting device of the radar system to continuously rotate. The UAV may control the flight of the UAV based on the detection information of the radar detecting device during the continuously rotation of the rotation device. The continuous rotation of the radar detecting device can allow the detection of farther and wider areas. Further, a continuously rotating scanning radar may be more adaptable to the environment with a higher scanning resolution.

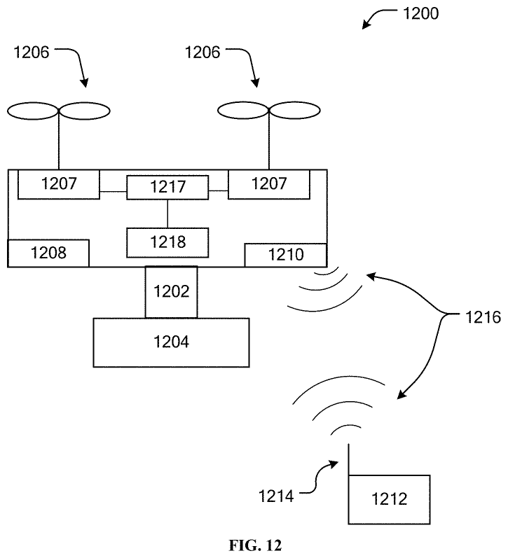

An embodiment of the present disclosure provides a UAV. FIG. 12 is a structural diagram of the UAV according to an embodiment of the present disclosure. As shown in FIG. 12, a UAV 1200 includes a body, a power system, a flight controller 1218, and a radar system 1208. The power system includes one or more of a propeller 1206, a motor 1207, and an electronic speed controller (ESC) 1217. The power system may be mounted on the body for providing flight power. The flight controller 1218 may be in communication with the power system for controlling the UAV to fly.

In the present embodiment, the specific principles and implementation manners of the radar system 1218 are similar to the previous embodiments, and details are not described herein again. In addition, the specific principles and implementation manners of the flight controller 1218 are similar to the previous embodiments, and details are not described herein again.

In addition, as shown in FIG. 12, the UAV 1200 further includes a communication system 1210, a supporting device 1202, and an imaging device 1204. The supporting device 1202 may specifically be a gimbal. The communication system 1210 may specifically include a receiver for receiving a wireless signal transmitted by an antenna 1214 of a ground station 1212. In some embodiments, an electromagnetic wave 1216 may be generated during the communication between the receiver and the antenna 1214.

In the present embodiment, the rotation device of the radar system may be controlled by the UAV to continuously rotate the rotation device. During the continuously rotation of the rotation device, the rotation device may drive the radar detecting device of the radar system to continuously rotate. The UAV may control the flight of the UAV based on the detection information of the radar detecting device during the continuously rotation of the rotation device. The continuous rotation of the radar detecting device can allow the detection of farther and wider areas. Further, a continuously rotating scanning radar may be more adaptable to the environment with a higher scanning resolution.

In the several embodiments provided by the present disclosure, it should be understood that the disclosed apparatus and method may be implemented in other manners. For example, the apparatus embodiments described above are merely illustrative. For example, the unit division is merely logical function division and there may be other division in actual implementation. For example, multiple units or components may be combined or integrated into another system, or some features can be omitted or not be executed. In addition, the mutual coupling or the direct coupling or the communication connection as shown or discussed may be indirect coupling or communication connection through some interfaces, devices or units, and may be in electrical, mechanical or other forms.

The units described as separate components may or may not be physically separated. The components displayed as units may or may not be physical units, that is, may be located in one place or may also be distributed to multiple network units. Some or all of the units may be selected according to actual needs to achieve the objectives of the solution in the disclosure.

In addition, each functional unit in each embodiment of the present disclosure may be integrated into one processing unit, or each unit may exist alone physically, or two or more units may be integrated in one unit. The above-mentioned integrated unit can be implemented in the form of hardware or in the form of hardware plus software functional unit.

The above-described integrated unit implemented in the form of a software functional unit may be stored in a computer-readable storage medium. The software function unit is stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Those skilled in the art may clearly understand that, for convenience and brevity of description, the division of the foregoing functional modules is only used as an example. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

Finally, it should be noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

What is claimed is:

1. An unmanned aerial vehicle (UAV) obstacle avoidance control method comprising:
controlling a rotation device to perform a continuous rotation that drives a radar detecting device to continuously rotate, the rotation device being disposed on a body of a UAV and carrying the radar detecting device;
acquiring detection information of the radar detecting device during the continuous rotation; and
controlling the UAV to fly based on the detection information.

2. The method of claim 1, wherein the radar detecting device is vertically mounted above the body of the UAV through the rotation device, and a rotation axis of the radar detecting device is parallel to a yaw axis of the UAV.

3. The method of claim 1, further comprising: acquiring the detection information of the radar detecting device generated from detecting one or more of an obstacle in front of the UAV, an obstacle behind the UAV, or an obstacle above the UAV.

4. The method of claim 3, wherein the detection information includes one or more of a distance, a speed, a direction, or a height of the obstacle relative to the UAV.

5. The method of claim 4, wherein controlling the UAV to fly based on the detection information includes:
controlling the UAV to avoid the obstacle based on the detection information.

6. The method of claim 5, further comprising: after controlling the UAV to avoid the obstacle:
controlling the UAV to return to a predetermined route.

7. The method of claim 4, wherein controlling the UAV to fly based on the detection information includes:
adjusting, based on the detection information, at least one of a pre-planned route or planning information of an agricultural operation, and
controlling the UAV to continue a flight operation based on at least one of the adjusted route or the adjusted planning information of the agricultural operation.

8. The method of claim 1, wherein the radar detecting device is horizontally mounted under the body of the UAV through the rotation device, and a rotation axis of the radar detecting device is perpendicular to a yaw axis of the UAV.

9. The method of claim 8, wherein a beam indicating a maximum detection direction of the radar detecting device and the yaw axis of the UAV are at a first predetermined angle.

10. The method of claim 9, wherein the detection information includes one or more of a height of the UAV from a ground or a terrain of the ground below the UAV within the first predetermined angle.

11. The method of claim 10, wherein controlling the UAV to fly based on the detection information includes:
controlling a flight height of the UAV based on the height of the UAV from the ground.

12. The method of claim 10, wherein controlling the UAV to fly based on the detection information includes:
controlling the UAV to perform terrain tracking based on the terrain of the ground below the UAV within the first predetermined angle.

13. The method of claim 1, wherein the radar detecting device includes a control circuit board and one or more radio frequency antennas, and the control circuit board and the one or more radio frequency antenna are electrically connected.

14. The method of claim 13, wherein an angle between a board surface of the radio frequency antenna and a board surface of the control circuit board is a second predetermined angle.

15. The method of claim 14, wherein the radar detecting device includes the control circuit board, a first radio frequency antenna, and a second radio frequency antenna, and the control circuit board is disposed between the first radio frequency antenna and the second radio frequency antenna.

16. The method of claim 1, wherein the rotation device includes:
a turntable configured to carry the radar detecting device;
an electronic speed control board electrically connected to a motor for driving the motor and controlling a rotation state of the motor, the motor is used to drive the turntable to rotate; and
an interface board electrically connected to the electronic speed control board and/or the radar detecting device, the interface board being used for external electrical connection.

17. The method of claim 1, wherein the radar detecting device detects a target object around the UAV through a digital beam forming (DBF).

18. The method of claim 1, wherein the UAV includes an agricultural UAV.

19. A radar system comprising:
a radar detecting device; and
a rotation device, wherein
the rotation device is disposed on a body of a UAV and carries the radar detecting device,
the rotation device is configured to drive the radar detecting device to continuously rotate, and
the radar detecting device is configured to, when the rotation device drives the radar detecting device to continuously rotate, scan and detect an obstacle around the UAV.
